(19) United States
(12) Patent Application Publication
(10) Pub. No.: US 2010/0105015 A1
(43) Pub. Date: Apr. 29, 2010

(54) SYSTEM AND METHOD FOR FACILITATING THE DECODING OR DECIPHERING OF FOREIGN ACCENTS

(76) Inventors: Judy Ravin, Ann Arbor, MI (US); Corissa Niemann, Ypsilanti, MI (US)

Correspondence Address: DYKEMA GOSSETT PLLC, 39577 WOODWARD AVENUE, SUITE 300, BLOOMFIELD HILLS, MI, 48304-5086, US

(21) Appl. No.: 12/579,573

(22) Filed: Oct. 15, 2009

Related U.S. Application Data
(60) Provisional application No. 61/107,871, filed on Oct. 23, 2008.

(51) Int. Cl. G09B 19/00; G09B 5/00

(52) U.S. Cl. 434/169; 434/185

(57) ABSTRACT

A system for decoding foreign accents includes a visual display monitor, an audio display device, and a processor. The processor is electrically connected to, and configured for communication with, the visual display monitor and the audio display device. The processor is further configured to exert a measure of control over the visual display monitor and the audio display device to display aural and visual content. The processor is still further configured to train a user of the system to understand the nature of a mispronunciation of a native language word by a foreign language speaker, and to comprehend a response thereto. The processor is yet still further configured to validate the user's understanding and comprehension by allowing the user to determine whether his response to a mispronunciation was accurately performed following an aural display of the mispronunciation through the audio display device.

### CROSS REFERENCE TO RELATED APPLICATIONS

This application claims the benefit of U.S. Provisional Application Ser. No. 61/107,871 entitled Method of Decoding Foreign Accents, filed Oct. 23, 2008 and hereby incorporated by reference in its entirety.

### FIELD OF THE DISCLOSURE

The field of the present disclosure is generally linguistics. More particularly, the present disclosure relates to a method for teaching a user to decode, decipher, and/or comprehend foreign accents, and a system for performing the same.

### BACKGROUND

It is well known that language barriers often make it difficult for speakers of two different languages to effectively communicate with each other. More particularly, native language speakers of a particular language (e.g., English) often have a difficult time understanding and comprehending what non-native speakers of that language (i.e., foreign language speakers) are saying due to the non-native speaker's foreign accent when speaking the particular language.

Taking, for exemplary purposes only, a native English speaker and a non-native English speaker (i.e., a foreign language speaker). The non-native speaker will often pronounce words and/or sentences differently than the native English speaker. As a result, miscommunications and misunderstandings between the respective speakers often occur thereby rendering the communication between these speakers ineffective. Depending on the situation in which these speakers interact, this can lead to a loss of time, productivity, profit, or more serious consequences.

One way these “language barriers” have been addressed is to employ accent reduction training for non-native speakers of a particular language. This training aims to eliminate, or at least substantially reduce, the non-native speaker's accent when speaking the particular language. However, this training is not without its drawbacks.

For example, accent reduction training is not always widely available for all non-native speakers. As such, there is no guarantee that a non-native language speaker communicating with a native language speaker will have had this training. Therefore, there is a need for a system and method for training native language speakers to decode or decipher foreign accents that will minimize and/or eliminate one or more of the above-identified deficiencies.

### SUMMARY

The present disclosure is directed to a system for teaching a native language speaking user to decode or decipher foreign accents. In one exemplary embodiment, the system includes a visual display monitor, an audio display device, and a processor. The processor is electrically connected to, and configured for communication with, both the visual display monitor and the audio display device. The processor is further configured to exert a measure of control over the visual display monitor and the audio display device to display aural and visual content, respectively.

In one exemplary embodiment, the processor is still further configured to train a user of the system to understand the nature of a mispronunciation of a native language word by a foreign language speaker, and to comprehend a response to the mispronunciation. The processor is further configured to validate the user's understanding and comprehension by allowing the user to determine whether his response to a mispronunciation was accurately performed following an aural display of the mispronunciation through the audio display device.

Other systems, methods, and articles of manufacture relating to the decoding or deciphering of foreign accents are also presented.

Further features and advantages of the invention will become more apparent to those skilled in the art after a review of the disclosure in the accompanying drawings and detailed description.

### BRIEF DESCRIPTION OF THE DRAWINGS

FIG. 1 is a schematic block diagram of an exemplary embodiment of a system for teaching a native language speaking user to decode or decipher foreign accents, in accordance with the present disclosure.

FIG. 2 is a diagrammatic view of an exemplary embodiment of the system illustrated in FIG. 1, in accordance with the present disclosure.

FIG. 3 is a flow chart diagram showing an exemplary embodiment of a method for decoding or deciphering a foreign accent, in accordance with the present disclosure.

FIG. 4 is a flow diagram showing a portion of the data structure of the system illustrated in FIG. 1, in accordance with the present disclosure.

FIG. 5 is a flow chart diagram showing an assessing step of the method illustrated in FIG. 3, in accordance with the present disclosure.

FIG. 5A is an exaggerated diagrammatic view of one representation of the display of a visual display monitor of the system illustrated in FIG. 1, in accordance with the present disclosure.

FIG. 6 is a flow chart diagram showing a training step of the method illustrated in FIG. 3, in accordance with the present disclosure.

FIG. 6A is an exaggerated diagrammatic view of another representation of the display of a visual display monitor of the system illustrated in FIG. 1, in accordance with the present disclosure.

FIG. 7 is a flow chart diagram showing a validating step of the method illustrated in FIG. 3, in accordance with the present disclosure.

FIG. 7A is an exaggerated diagrammatic view of yet another representation of the display of a visual display monitor of the system illustrated in FIG. 1, in accordance with the present disclosure.

FIG. 8 is flow chart of a teaching step of the method illustrated in FIG. 3, in accordance with the present disclosure.

### DETAILED DESCRIPTION

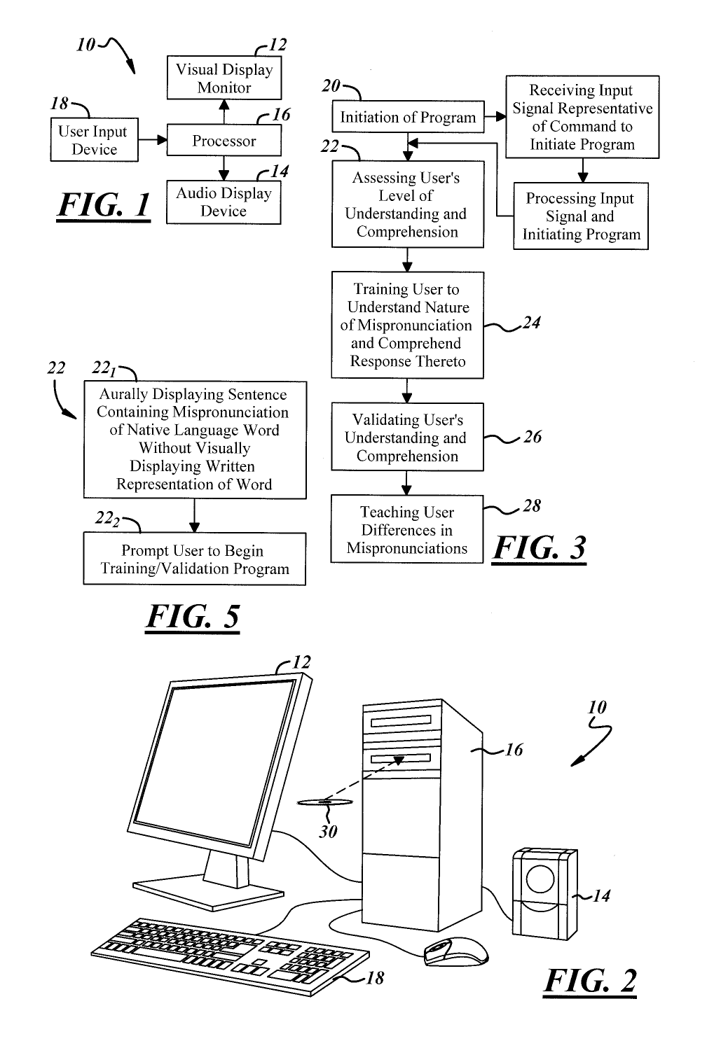

Referring now to the drawings wherein like reference numerals are used to identify identical components in the various views, FIG. 1 illustrates a schematic block diagram of one exemplary embodiment of a system 10 for teaching a native language speaking user to decode or decipher foreign accents (i.e., to recognize sound substitution patterns). In its most general form system 10 includes a visual display monitor 12, an audio display device 14, and a processor 16. Processor 16 is configured for, among other things, communication with, and to exert a measure of control over, each of visual display monitor 12 and audio display device 14. In another exemplary embodiment, system 10 further includes a user input device 18 that is configured for communication with processor 16. While the description below will be primarily directed to an embodiment of system 10 that includes user input device 18, it will be appreciated by those having ordinary skill in the art that other embodiments of system 10 exist wherein user input device 18 is not necessary (i.e., wherein the methodology performed by the system is done so without requiring user instructions or input). Those embodiments remain within the spirit and scope of the present disclosure.

With continued reference to FIG. 1, each of visual display monitor 12, audio display device 14, and user input device 18 are electrically connected to processor 16. Processor 16, in turn, is configured for communication to and/or from each of visual display monitor 12, audio display device 14, and user input device 18. In an exemplary embodiment, processor 16 is hardwired to each component such that the respective components are electrically connected to processor 16 through conventional means. However, in another exemplary embodiment, one or more of the components may be wirelessly connected to processor 16 such that the respective component(s) are electrically connected to processor 16 through wireless communications, as opposed to wires. Additionally, as briefly described above and as will be described in greater detail below, processor 16 is further configured to, among other things, exert a measure of control over visual display monitor 12 and audio display device 14. In an exemplary embodiment, this control is exerted, at least in part, in response to input signals generated by user input device 18 and received by processor 16.

With reference to FIG. 2, in one exemplary embodiment, system 10 takes the form of a computer system, such as, for exemplary purposes only, a desktop or laptop computer. While all of the components of system 10 in the illustrated embodiment are located in close proximity to each other, in other exemplary embodiments one or more components may be located remotely from the others. For example, in one exemplary embodiment wherein system 10 is an internet-based or networked system, the processor 16 may be a server or other type of distributed processor located remotely from the user input device 18, visual display monitor 12, and audio display device 14. In another exemplary embodiment, rather than taking the form of a conventional computer system (i.e., a desktop or laptop computer), system 10 may take the form of another electronic device, such as, for example and without limitation, a cellular telephone, smartphone, personal digital assistant (PDA), or the like. Accordingly, system 10 may be configured or arranged in any number of ways and each of these different configurations or arrangements remain within the spirit and scope of the present disclosure.

Visual display monitor 12 is generally configured to visually display content at the direction of processor 16 in human readable form (e.g., instructions, program menus, and other information). Accordingly, visual display monitor 12 is responsive to output signals from processor 16 to display certain content in written or visual form. It further facilitates the ability for the user to provide commands to processor 16 through, for example, user input device 18 (i.e., visual display monitor 12 displays instructions to the user to make a selection or enter a command via user input device 18).

In an exemplary embodiment, such as that illustrated in FIG. 2, visual display monitor 12 takes the form of a computer monitor. It will be appreciated by those having ordinary skill in the art, however, that visual display monitor 12 can take any number of forms that will allow a user to view content visually displayed thereon by processor 16. For example, in another exemplary embodiment, visual display monitor 12 may take the form of a television configured for connection to a processor such as processor 16 or the screen of a handheld device (e.g., cellular telephone, smartphone, PDA, etc.). In still another exemplary embodiment, visual display monitor 12 may take the form of an interactive touch screen display. In such an embodiment, at least visual display monitor 12 and user input device 18, may be combined as one structure performing different functions. Accordingly, those of ordinary skill in the art will appreciate that visual display monitor 12 may take the form of any number of known devices suitable for visually displaying content.

Audio display device 14 is configured to aurally display audible information or content (e.g., sounds, recorded messages, sound bytes, etc.). Audio display device 14 allows a user of system 10 to hear and listen to audible outputs of system 10, and processor 16, in particular. Accordingly, audio display device 14 is responsive to output signals from processor 16 to aurally display certain content stored on or accessed by processor 16. In an exemplary embodiment such as that illustrated in FIG. 2, audio display device 14 comprises one or more speakers of a computer system. The speaker(s) may be integral with one or more components of the computer system, or may be separate and distinct components that are connected to the computer system, and processor 16, in particular, either by wires or wirelessly.

In an embodiment of system 10 that includes user input device 18, user input device 18 is generally configured to allow a user to provide commands or instructions to processor 16. More particularly, user input device 18 is configured to instruct processor 16 to take certain actions or to perform certain tasks. With reference to FIG. 2, in an exemplary embodiment, user input device 18 takes the form of one or both of the computer keyboard and mouse. It will be appreciated by those having ordinary skill in the art, however, that user input device 18 may take any number of forms that will allow a user to interact with system 10, and processor 16, in particular. Accordingly, user input device 18 may take the form of any input device known in the art that can communicate with processor 16 (e.g., keyboard, mouse, key pad, touch screen, joystick, push buttons, switching devices, voice activation input devices, etc.). Additionally, user input device 18 may be integral with one or both of visual display monitor 12 and audio display device 14, or may be separate and distinct therefrom.

As set forth above, processor 16 is configured to, among other things, communicate with visual display monitor 12, audio display device 14, and user input device 18, as well as to exert a measure of control over both visual display monitor 12 and audio display device 14. Processor 16 is further configured to perform/facilitate the performance of a number of tasks/functions relating to a method of teaching a user of system 10 to decode or decipher foreign accents. More particularly, processor 16 is either loaded with, or is configured to access (i.e., memory or other storage medium), a software program that, when executed by processor 16, can be used to teach a native language speaking user to decode or decipher one or more foreign accents.

With reference to FIG. 3, processor 16 is configured to execute software to implement a methodology for teaching a user to recognize sound substitution patterns that generally comprises a plurality of steps. In a first step 20, processor 16 initiates or launches the program embodying the methodology. In one exemplary embodiment, processor 16 is responsive to an input from user input device 18 to initiate the program. The input may correspond to a selection of a particular foreign language, or may be a general command to initiate the program. However, in another exemplary embodiment, processor 16 is not responsive to user input device 18 to initiate the program, but rather receives instructions from a source in system 10 other than user input device 18. For example, in one exemplary embodiment, processor 16 may automatically initiate the program upon the start-up of system 10 (i.e., turning the system “on”).

In an exemplary embodiment, the methodology includes a second step 22 of assessing the user's level of (i) understanding of the nature of a mispronunciation of a native language word by a foreign language speaker, and (ii) comprehension of a response to the mispronunciation.

A third step 24 comprises training the user to (i) understand the nature of the mispronunciation of the native language word, and (ii) to comprehend an appropriate response thereto.

The methodology may further comprise a fourth step 26 of validating the user's understanding and comprehension by allowing the user to determine whether his response to a mispronunciation was accurately performed following an aural display of the mispronunciation.

In an exemplary embodiment, the methodology includes a fifth step 28 of teaching the user how mispronunciations of the same word differ when spoken by speakers of two or more different foreign languages.

It should be noted that while an exemplary embodiment of the methodology includes all five of the above-identified steps, in other exemplary embodiments the methodology comprises less than all five steps (i.e., in one exemplary embodiment, the second step of assessing the user's understanding and comprehension may be omitted, in another exemplary embodiment, fifth step 28 may be omitted, etc.). However, these embodiments remain within the spirit and scope of the present disclosure.

It should be further noted that system 10, as described herein, and processor 16, in particular, may include conventional processing apparatus known in the art, capable of executing instructions stored in an associated memory or other computer-readable medium that is accessible by processor 16, all performing in accordance with the functionality described herein. It is contemplated that the methods described herein, including without limitation the method steps briefly described above and illustrated in 3-8, will be programmed in a preferred embodiment, with the resulting software being stored in an associated memory or computer-readable storage medium, and where so described, may also constitute a means for performing such methods. Implementation of the invention, in software, in view of the following enabling disclosure, would require no more than routine application of programming skills by one of ordinary skill in the art. It is further contemplated that when the following methodology implemented in software is executed by processor 16, system 10 constitutes a special purpose machine.

With continued reference to FIG. 3, following the selection of a particular foreign language either by the user via user input device 18 or automatically by system 10 itself, or some other initiation of the methodology for a particular language (e.g., the software and its content correspond to only one foreign language, and therefore, no selection of a foreign language is required), processor 16 is configured to execute software such that processor 16 may then be configured to allow the native language speaking user to assess his understanding of (i) the nature of a mispronunciation of a native language word by a native speaker of the given foreign language (e.g., pronouncing the wrong sound or phoneme for a particular letter or combination of letters/phonemes, pronouncing the sound corresponding to a letter that is meant to be silent, etc.), and (ii) his comprehension of a response to the mispronunciation. In addition, or alternatively, processor 16 is configured to execute software such that processor 16 may then be configured to train the native language speaking user to understand the nature of a mispronunciation of a native language word by a native speaker of the given foreign language, and to comprehend a response to the mispronunciation. Processor 16 may still further be configured to execute software such that processor 16 may then be configured to allow the native language speaking user to validate his understanding and comprehension.

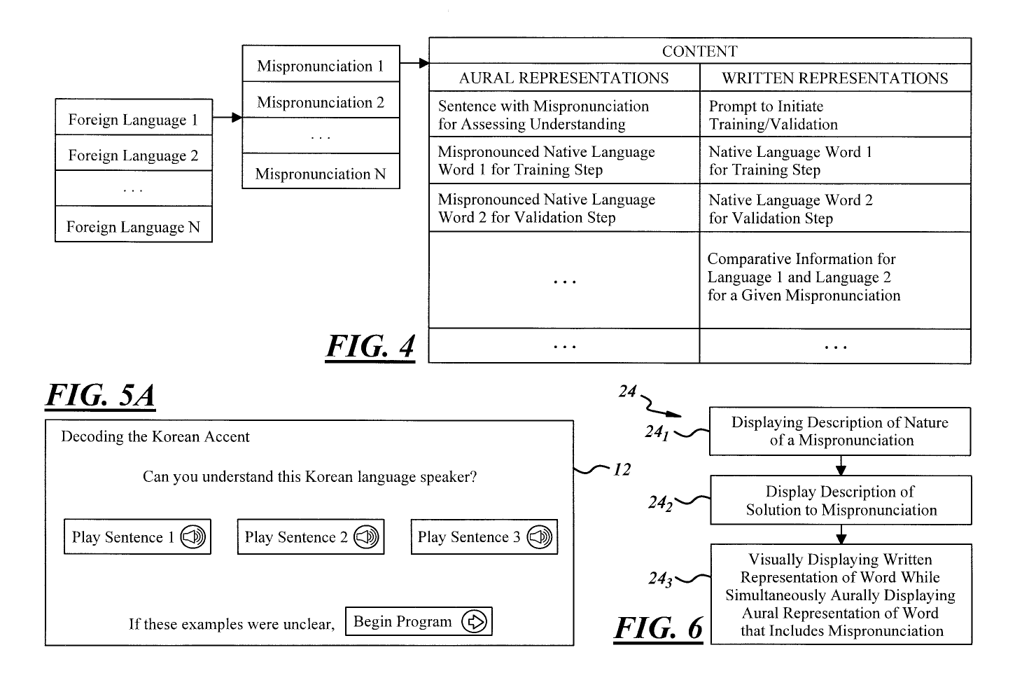

In an exemplary embodiment, processor 16 may yet still further be configured to execute software such that processor 16 may then be configured to teach the user differences in mispronunciations between speakers of different foreign languages. To carry out or perform these tasks/functions, the software program contains, as illustrated in FIG. 4, certain predetermined content corresponding to one or more foreign languages. More specifically, and as will be described in greater detail below, this content corresponds to both written (or visual) and aural (or audio) representations of certain words, sentences, instructions, and other content that lends itself to visual and/or aural display. Each of the tasks/functions briefly described above will now be described in greater detail.

With reference to FIG. 5, in an exemplary embodiment, system 10, and processor 16, in particular, is configured to effectively allow a user to assess his level of (i) understanding of the nature of one or more mispronunciations of one or more native language words by a foreign language speaker, and (ii) comprehension of response(s) to the mispronunciation(s) (step 22). More particularly, following the selection of a particular foreign language, system 10 is configured to aurally display one or more sentences spoken with the accent of a native speaker of the given foreign language (i.e., spoken by a speaker of the language) such that it contains one or more mispronunciations of a native language word(s), without simultaneously visually displaying the sentence(s) in written form. Accordingly, the user must listen to the sentence(s) and then determine whether he understood and comprehended what he heard without seeing the sentence(s) in written form.

By way of example, and with reference to FIG. 5A, assume a user is being taught to decode or decipher the Korean accent. The native-language user listens to a sentence spoken with a Korean accent (i.e., by a native Korean language speaker) that includes a native language word, such as, for example, “foxhole.” Because Korean speakers often substitute the sound (or phoneme) corresponding to the letter “p” for the sound (or phoneme) corresponding to the letter “f,” the user will hear “foxhole” as “poxhole.” In another example, the user may listen to a sentence spoken by a native Korean language speaker that includes the native language word “zero.” Because Korean speakers often substitute the sound (or phoneme) corresponding to the letter “j” for the sound (or phoneme) corresponding to the letter “z,” the user will hear “zero” as “jero.” Thus, the user must determine, after listening to the sentences, whether he (i) understands that Korean speakers often mispronounce words that include the sounds “f” and “z,” and (ii) comprehended that respective substitutions of the “p” and “j” sounds he heard with “f” and “z” sounds, respectively, must be made to understand the sentence. If the user did not understand the sentence(s), then, in an exemplary embodiment, he may elect to commence a training program to learn how to “decode” the Korean accent. In such an embodiment, after aurally displaying one or more sentences, system 10, and processor 16, in particular, is configured to prompt the user to begin a training and validation program or routine by entering a command via user input device 18. The user may be prompted via visual display monitor 12 (see, for example, FIG. 5A) and/or audio display device 14. Alternatively, the training program may commence without the user's input.

Accordingly, in an exemplary embodiment, and with reference to FIGS. 4 and 5, by executing a software program or routine, processor 16 is configured, in a substep 22₁ of step 22, to generate an output signal operative to reproduce a certain portion of the content corresponding to aural representations of the sentence(s) used to assess the user's level of understanding and comprehension of the given foreign accent. In one exemplary embodiment, processor 16 is responsive to an input from user input device 18 to processor 16 to generate this signal. However, in other exemplary embodiments, no such user input is required. Processor 16 is further configured to deliver the generated output signal to audio display device 14 where it is aurally displayed. Therefore, processor 16 controls audio display device 14 to cause the aural representation of the sentence to be displayed for the user to hear. In an exemplary embodiment, processor 16 is further configured, in a substep 22₂ of step 22, to generate another output signal operative to reproduce a portion of the content corresponding to a message to the user asking the user to provide a command to processor 16 to initiate the training and validation steps of the program if the user did not understand or comprehend the aurally displayed sentence(s). In such an embodiment, processor 16 is further configured to deliver the output signal to one or both of visual display monitor 12 and audio display device 14 where it is visually (i.e., in human-readable format) and/or aurally displayed. If the user instructs processor 16 to begin the training and validation step, the processor 16 initiates these steps of the program.

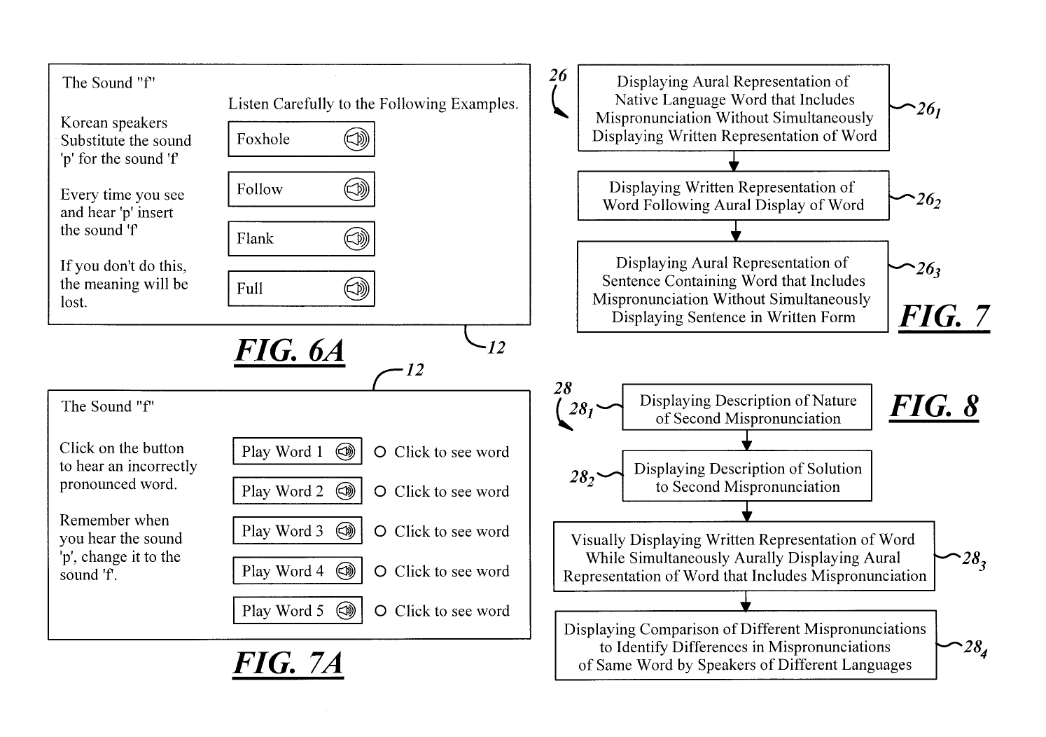

As briefly described above, and with reference to FIG. 6, whether or not the methodology employed by system 10 includes the above described assessment step, in an exemplary embodiment, system 10, and processor 16, in particular, is configured to effectively train a user to understand the nature of a mispronunciation of a native language word by a speaker of a given foreign language, and to comprehend a correct response to the mispronunciation (step 24). More specifically, following the selection of a particular foreign language, system 10 is configured to teach the user the nature of one or more common mispronunciations of native language words by speakers of the given foreign language, and what substitutions the user should make to understand what the foreign language speaker is saying (i.e., to decode or decipher the foreign accent). In an exemplary embodiment, system 10 is configured to carry out this training by first displaying a description of the mispronunciation (i.e., identifying the foreign language sound or phoneme pronounced by the foreign language speaker when pronouncing a native language word). This may be displayed on one or both of visual display monitor 12 and audio display device 14. System 10 is further configured to display the required solution to the mispronunciation—namely, providing the user with a native language phoneme that is to be substituted for the foreign language phoneme. This may be displayed on one or both of visual display monitor 12 and audio display device 14. Finally, system 10 is still further configured to demonstrate the substitution by aurally displaying, via audio display device 14, an aural representation of a native language word containing the foreign language phoneme (i.e., the word is mispronounced), while simultaneously displaying the native language word in written or visual form on video display monitor 12.

Using the example from above of decoding the Korean accent, and with reference to FIG. 6A, system 10 would describe to the user that when saying native language words having a sound corresponding to the letter “f,” native Korean language speakers substitute the sound corresponding to the letter “p” for the sound corresponding to the letter “f.” Similarly, when saying native language words having a sound corresponding to the letter “z,” native Korean language speakers substitute the sound corresponding to the letter “j” for the sound corresponding to the letter “z.” System 10 is configured to then explain to the user that when he hears the sounds corresponding to the letters “p” and “j,” he may need to replace them with the sounds corresponding to the letters “f” and “z,” respectively, to understand what he heard. To reinforce the solution to the mispronunciation, system 10 displays, through audio display device 14, an aural representation of a word containing the mispronunciation (i.e., foreign language phoneme), while simultaneously displaying the native language word in visual or written form on video display monitor 12. For example, system 10 may display through audio display device 14 an aural representation of the word “Foxhole” containing the above described mispronunciation, such that the aural display sounds like “Poxhole.” Simultaneously, system 10 displays the word “Foxhole” on video display monitor 12 (see FIG. 6A).

Accordingly, with reference to FIGS. 4 and 6, by executing a software program or routine, in an exemplary embodiment, processor 16 is configured, in a substep 24₁ of step 24, to generate an output signal operative to reproduce a certain portion of the content corresponding to a description of the nature of a mispronunciation of a native language word by a speaker of the particular foreign language. Processor 16 is further configured to deliver the output signal to one or both of video display monitor 12 and audio display device 14 where it is visually displayed, aurally displayed, or both. The description displayed to the user identifies a foreign language phoneme pronounced by the foreign language speaker when pronouncing the native language word.

With continued reference to FIGS. 4 and 6, processor 16 is further configured, in a substep 24₂ of step 24, to generate an output signal operative to reproduce a certain portion of the content corresponding to a description of the solution to the mispronunciation. Processor 16 is still further configured to deliver the output signal to one or both of video display monitor 12 and audio display device 14 where it is visually displayed, aurally displayed, or both. The description displayed to the user provides the user with a native language phoneme to be substituted for the foreign language phoneme.

Finally, processor 16 is yet still further configured, in a substep 24₃ of step 24, to generate one or more output signals operative to reproduce (i) a certain portion of the content corresponding to an aural representation of a native language word containing the foreign language phoneme (i.e., the word is mispronounced), but that would include the native language phoneme if correctly pronounced, and (ii) a certain portion of the content corresponding to a written representation of the native language word. Processor 16 is further configured to deliver the output signal(s) to video display monitor 12 and audio display device 14 where the respective written and aural representations are simultaneously visually and aurally displayed. In one exemplary embodiment, processor 16 is responsive to an input command for user input device 18 to processor 16 to display the aural representation of the word. It will be appreciated, though, that in other embodiments, no such user input is required. Accordingly, the user is told what the mispronunciation of a word is and then what substitution to make to in order to translate, decode, decipher or correct the mispronunciation. The user is then visually shown the word while listening to the mispronunciation so that he can clearly see, understand, and comprehend the mispronunciation and associate the pattern of substituting a specific sound for a mispronounced one.

As briefly described above, and with reference to FIG. 7, in an exemplary embodiment, once the native language speaking user has been trained with respect to one or more mispronunciations for a given foreign language, and understands the required native language phonemes for foreign language phoneme substitutions, the user's training can be validated (step 26). More specifically, the user can put his training to test by: (i) listening to aural representations of a word containing a mispronunciation without simultaneously seeing the word; (ii) making the phoneme substitution the user believes is required; and then (iii) viewing a written representation of the word to see if he made the correct substitution. Therefore, in an exemplary embodiment, system 10 is configured to allow the user to validate his understanding and comprehension by first displaying, through audio display device 14, an aural representation of a word that contains the foreign language phoneme (i.e., the word is mispronounced), but that would include the native language phoneme if correctly pronounced, without simultaneously displaying, on visual display monitor 12, a written representation of the native language word. After a predetermined amount of time, or in response to a user command, system 10 is configured to display, on visual display monitor 12, a written representation of the word to verify the user's substitution.

Using the example from above of decoding the Korean accent, and with reference to FIG. 7A, system 10 would display an aural representation of a word that includes the foreign language phoneme corresponding to the letter “p”, but that would contain the native language phoneme corresponding to the letter “f” if correctly pronounced. For example, system 10 may aurally display an aural representation of the word “Face” that contains the above described mispronunciation, such that the aural display sounds like “Pace.” After a period of time, or in response to a command, system 10 would then visually display the word “Face.”

Accordingly, with continued reference to FIGS. 4 and 7, by executing a software program or routine, in an exemplary embodiment, processor 16 is configured, in a substep 26₁ of step 26, to generate an output signal operative to reproduce a certain portion of the content corresponding to an aural representation of a native language word that includes the foreign language phoneme, but that would contain the native language phoneme if correctly pronounced. In one exemplary embodiment, processor 16 is responsive to an input from user input device 18 to processor 16 to generate this signal. However, in other exemplary embodiments, no such user input is required. Though not required, in an exemplary embodiment the aurally displayed word is a different word than that used in the training phase described above. Additionally, the aural representation of the word may be displayed alone (i.e., one word) or as part of a larger sentence. In either instance, processor 16 is further configured to deliver the output signal to audio display device 14 where the aural representation of the native language word is aurally displayed, and done so without the visual display of the word.

Processor 16 is still further configured, in a substep 26₂ of step 26, to generate another output signal that is operative to reproduce a certain portion of the content corresponding to a visual or written representation of the native language word. Processor 16 is yet still further configured to deliver the output signal to the visual display monitor where the word is visually displayed (i.e., in human readable form). In an exemplary embodiment, processor 16 is configured to display the written representation after a predetermined amount of time lapses following the display of the aural representation, so as to give the user a sufficient amount of time to make the necessary phoneme substitutions. In another exemplary embodiment, processor 16 is configured to receive an input signal from user input device 18 instructing processor 16 to display the written representation. By providing the written representation following the aural representation, the user is able to verify whether he made the correct substitution of the native language phoneme for the foreign language phoneme.

Once the aforedescribed methodology for one mispronunciation for a given foreign language is complete, the methodology may be repeated for other mispronunciations made by native speakers of the given foreign language. This allows the user to develop a set of phoneme substitutions for the given language to help him better decode or decipher the accents of speakers of the particular foreign language. If the assessment, training, and/or validation described above is performed for multiple mispronunciations, the user's overall training can be validated by displaying an aural representation of a sentence that includes multiple words containing one or more mispronunciations, without also simultaneously displaying a written representation for the sentence. In such an embodiment, the user would then make the phoneme substitutions the user believes are required, and then view a written representation of the sentence to see if he made the correct substitutions. Other than using multiple words as opposed to a single word, this process is the same as that described above with respect to validating the user's understanding and comprehension of a mispronunciation using a single word. Accordingly, the process will not be repeated here.

Additionally, in an exemplary embodiment, system 10 is configured such that the above-described methodology may be carried out with respect to multiple foreign languages. In such an embodiment, the user may be presented a menu containing a list of foreign languages from which the user may make a selection. This menu may be displayed on one or both of visual display monitor 14 and audio display device 16. Accordingly, processor 16 is configured to generate and display a user-selectable menu, and to receive from user input device 18, for example, the user's selection. Based on that selection, processor 16 is further configured to initiate the aforementioned methodology for the selected language. Alternatively, the system 10 may be configured to automatically select a foreign language with which to carry out the methodology, or may be configured in such a way that the user progresses through each language one at a time in a predetermined order such that the user works completely through the methodology for a language number one, then moves to a predetermined language number two without the user making any selections.

With reference to FIG. 8, when system 10 is configured to allow for the decoding or deciphering of multiple foreign accents at one time, it may be further configured to teach the user differences in the mispronunciations of the same words by speakers of different foreign languages (step 28). More specifically, once the aforedescribed methodology, or at least a portion thereof, is performed for two or more foreign languages, processor 16 may be configured to generate a comparison, or at least display a comparison, of different foreign language phonemes corresponding to the same native language phoneme. This allows the user to see how mispronunciations of the same word(s) differ depending on the particular foreign languages. In such an embodiment, like the written and aural representations, the comparative information may be part of the content of the software. Accordingly, with reference to FIGS. 4 and 8, by executing a software program or routine, processor 16 may be configured, in a substep 28₁ of step 28, to generate an output signal that is operative to reproduce the comparative information. In one exemplary embodiment, processor 16 is responsive to an input from user input device 18 to processor 16 to generate this signal. However, in other exemplary embodiments, no such user input is required. Processor 16 is further configured to deliver the output signal to either one or both of visual display monitor 12 or audio display device 14 where it is visually displayed, aurally displayed, or both.

As briefly described above, the software executed by processor 16 to carry out or perform the above described methodology may be loaded on processor 16 or stored in a computer-readable storage medium that is accessible by processor 16. In an exemplary embodiment, processor 16 may be pre-programmed with the software to carry out the above described methodology/functionality. In another exemplary embodiment processor 16 is configured to be programmed to perform the above described functionality. In still another exemplary embodiment, the software is not stored or loaded onto processor 16, but rather is accessed by processor 16.

More particularly, in one exemplary embodiment, the software is stored in a storage medium or memory within the computer system 10 that is part of, or can be accessed by, processor 16. In another exemplary embodiment, the software is encoded on a computer-readable storage medium that is accessed by processor 16. In such an embodiment, the computer-readable storage medium, which may comprise any known computer-readable storage medium, such as, for exemplary purposes and without limitation, CD-ROMs, flash drives, floppy disks, diskettes, and other suitable storage medium known in the art, may be inserted into an appropriate drive or I/O port of the computer that is accessible by processor 16 (see, for example, computer-readable medium 30 illustrated in FIG. 2), and the computer program encoded thereon is executed from its current location. In another exemplary embodiment, the computer program is copied from the computer-readable medium into a storage device (i.e., memory) that is accessible to processor 16, and then executed by processor 16. In yet another exemplary embodiment, and as will be described below, the computer program is stored in a storage medium or memory that is separate and distinct from system 10, but that is accessible by system 10 (e.g., processor 16) such that the computer program may be executed from its current location by processor 16 or downloaded or copied from the separate and distinct storage medium/memory and then executed by processor 16 (e.g., in an internet or PDA-based arrangement, for example, wherein the computer program may be stored on a server or on some other computer system that may be accessed by system 10).

Therefore, in accordance with another aspect of the present disclosure, an article of manufacture is provided that comprises a computer-readable storage medium having a computer program encoded thereon, the computer program including code that, when executed by a computer, causes the computer to carry out or perform the methodology described in great detail above—namely, teaching a native language speaking user to decode or decipher foreign accents.

As briefly described above, in another exemplary embodiment, the software executed by processor 16 may be stored in a storage medium that is separate and distinct from system 10, but accessible thereby. One example of such an arrangement is where system 10 constitutes a client computer having a web browser that is configured for connection to, and communication over, a network (e.g., the communication of html or other mark-up language, for example, via http over TCP/IP, for example). In such an embodiment, the software may be stored or hosted on a server or other storage medium that is also connected to (or accessible by) the network, and that is configured for communication with the client computer via the network. For instance, in one embodiment a user may be able to access a website over the internet via the browser associated with the user's computer (i.e., client computer) and access the software that is stored on a server associated with the website (i.e., hosted application). This software may be downloaded from the website (i.e., the server or storage medium associated therewith), or it may be executed from its current location. In the latter instance, the methodology embodied by the software program would be performed directly from the website accessed by the user (as opposed to the computer program being downloaded or copied by system 10 and then executed locally thereby). Accordingly, in another aspect of the invention, the above described methodology may include a step of communicating a computer program from a remotely located computer system over a computer network to a client computer wherein the computer program, when rendered by a browser on a client computer, performs the steps of the methodology set forth in great detail above.

While the present disclosure has been particularly shown and described with reference to the preferred embodiments thereof, it is well understood by those skilled in the art that various changes and modifications can be made without departing from the spirit and scope of the invention. These changes and modifications remain within the spirit and scope of this disclosure.

1. A system for teaching a native language speaking user to decode or decipher foreign accents, comprising:
a visual display monitor;
an audio display device; and
a processor, said processor electrically connected to, and configured for communication with, said visual display monitor and said audio display device, and further configured to control said visual display monitor and said audio display device to display certain aural and visual content, said processor still further configured:
to train said user to understand the nature of a mispronunciation of a native language word by a foreign language speaker, and to comprehend a response to said mispronunciation; and
to validate said user's understanding and comprehension by allowing said user to determine whether said response was accurately performed following an aural display of said mispronunciation through said audio display device.

2. The system of claim 1, further comprising a user input device electrically connected to said processor and configured for communication therewith, said processor further configured to be responsive to inputs received from said user input device.

3. The system of claim 1, wherein said processor is further configured to allow said user to initially assess whether said user has a desired level of (i) understanding of the nature of said mispronunciation, and (ii) comprehension of said response thereto.

4. The system of claim 3, wherein said processor is configured to assess said understanding and comprehension by generating an output signal configured to control said audio output device to aurally display a portion of said content corresponding to an aural representation of a sentence containing said mispronunciation of said native language word without displaying said sentence in written form.

5. The system of claim 1, wherein said processor is configured to train said user by:
generating an output signal configured to cause a portion of said content corresponding to a description of the nature of said mispronunciation to be displayed on at least one of said visual display monitor and said audio display device, wherein said description comprises an identification of a foreign language phoneme pronounced by said foreign language speaker when pronouncing said native language word;
generating an output signal configured to cause a portion of said content corresponding to a description of a solution to said mispronunciation to be displayed on at least one of said visual display monitor and said audio display device, wherein said description of a solution comprises providing a native language phoneme to be substituted for said foreign language phoneme; and
generating at least one output signal configured to control said visual display monitor to display a certain portion of said content corresponding to a written representation of a first native language word, and said audio display device to simultaneously display a certain portion of said content corresponding to an aural representation of said first word that includes said foreign language phoneme, but that would include said native language phoneme if pronounced correctly.

6. The system of claim 5, wherein said processor is configured to validate said user's understanding and comprehension by:
generating an output signal configured to control said audio display device to display a certain portion of said content corresponding to an aural representation of a second native language word that includes said foreign language phoneme, but that would contain said native language phoneme if correctly pronounced, without simultaneously displaying a written representation of said second word; and
generating an output signal to control said visual display monitor to display a certain portion of said content corresponding to a written representation of said second word following said aural display of said second word to allow said user to verify the correct substitution of said native language phoneme for said foreign language phoneme was made.

7. The system of claim 5, wherein said foreign language phoneme is a first foreign language phoneme and said mispronunciation is a first mispronunciation, and said first foreign language phoneme and said first mispronunciation correspond to a first foreign language, said processor further configured to teach said user differences in mispronunciations of said native language phoneme by:
generating an output signal configured to cause a portion of said content corresponding to a description of the nature of a second mispronunciation of said native language word by a speaker of a second foreign language to be displayed on at least one of said visual display monitor and said audio display device, wherein said description comprises an identification of a second foreign language phoneme pronounced by said speaker of said second foreign language when pronouncing said native language word;
generating an output signal configured to cause a portion of said content corresponding to a description of a solution to said second mispronunciation to be displayed on at least one of said visual display monitor and said audio display device, wherein said description of a solution comprises providing said user with said native language phoneme to be substituted for said second foreign language phoneme;
generating at least one output signal configured to control said visual display monitor to display a portion of said content corresponding to a written representation of said first word, and said audio display device to simultaneously display a portion of said content corresponding to an aural representation of said first word that includes said second foreign language phoneme, but that would contain said native language phoneme if pronounced correctly; and
generating an output signal configured to cause a portion of said content corresponding to a comparison of said first and second foreign language phonemes to be displayed on at least one of said visual display monitor and audio display device to identify at least one difference in the mispronunciations of said native language phoneme by speakers of said first and second languages.

8. The system of claim 5, wherein said processor is configured to validate said user's understanding by generating an output signal configured to control said audio display device to aurally display a portion of said content corresponding to an aural representation of a sentence containing a native language word that includes said foreign language phoneme without displaying said sentence in written form and allowing said user to determine whether said user understands and comprehends said sentence.

9. An article of manufacture, comprising:
a computer-readable storage medium having a computer program encoded thereon for teaching a native language speaking user to decode or decipher foreign accents, said computer program including code that, when executed on a computer, causes the computer to perform the following steps:
training said user to understand the nature of a mispronunciation of a native language word by a foreign language speaker, and to comprehend a response to said mispronunciation; and
validating said user's understanding and comprehension by allowing said user to determine whether said response was accurately performed following an aural display of said mispronunciation through an audio display device.

10. The article of manufacture of claim 9, wherein said computer program further includes code that, when executed by a computer, causes the computer to perform the step of controlling said audio output device to aurally display a sentence containing said mispronunciation of said native language word without displaying said sentence in written form, thereby allowing said user to assess whether said user has a desired level of understanding of the nature of said mispronunciation, and comprehension of said response thereto.

11. The article of manufacture of claim 9, wherein said code of said computer program that, when executed by a computer, causes said computer to perform said training step further includes code that, when executed by a computer, causes the computer to perform the following substeps:
controlling at least one of a visual display monitor and said audio display device to display a description of the nature of said mispronunciation, wherein said description comprises identifying a foreign language phoneme pronounced by said foreign language speaker when pronouncing said native language word;
controlling at least one of said visual display monitor and said audio display device to display a description of a solution to said mispronunciation, wherein said description comprises providing a native language phoneme to be substituted for said foreign language phoneme; and
further controlling said visual display monitor to display a written representation of a first native language word, while controlling said audio display device to simultaneously display an aural representation of said first word that includes said foreign language phoneme, but that would contain said native language phoneme if correctly pronounced.

12. The article of manufacture of claim 11, wherein said code of said computer program that, when executed by a computer, causes said computer to perform said validating step further includes code that, when executed by a computer, causes the computer to perform the following substeps:
controlling said audio display device to display an aural representation of a second native language word that includes said foreign language phoneme, without simultaneously displaying a written representation of said second word; and
controlling said visual display monitor to display a written representation of said second word following said aural display of said second word to allow said user to verify the correct substitution of said native language phoneme for said foreign language phoneme was made.

13. The article of manufacture of claim 11, wherein code of said computer program further includes code that, when executed by a computer, causes the computer to perform the step of controlling said audio display device to display an aural representation of a sentence containing a native language word and that includes said foreign language phoneme, without displaying said sentence in written form to allow said user to determine whether said user understands and comprehends said sentence.

14. A method of decoding or deciphering foreign accents implemented on a computer system comprising a visual display monitor, an audio display device, and a processor, said method comprising the steps of:
training a native language speaking user to understand the nature of a mispronunciation of a native language word by a foreign language speaker, and to comprehend a response to said mispronunciation by causing said process to display at least one of visual and audio content on said corresponding visual display monitor and audio display device; and
validating said user's understanding and comprehension by allowing said user to determine whether said response was accurately performed following an aural display of said mispronunciation through said audio display device.

15. The method of claim 14, further comprising the step of assessing said user's level of understanding of the nature of said mispronunciation and comprehension of said response thereto prior to training said user, wherein said assessing step comprises the substeps of:
generating, by said processor, an output signal configured to control said audio display device to aurally display an aural representation of a sentence containing said mispronunciation of said native language word without displaying a written representation of said sentence on said visual display monitor.

16. The method of claim 14, wherein said training step comprises the substeps of:
generating, by said processor, an output signal configured to cause a description of the nature of said mispronunciation to be displayed on at least one of said visual display monitor and said audio display device, wherein said description comprises an identification of a foreign language phoneme pronounced by said foreign language speaker when pronouncing said native language word;
generating, by said processor, an output signal configured to cause a description of a solution to said mispronunciation to be displayed on at least one of said visual display monitor and said audio display device, wherein said description of a solution comprises providing a native language phoneme to be substituted for said foreign language phoneme; and
generating, by said processor, at least one output signal configured to control said visual display monitor to display a written representation of a first native language word, and said audio display device to simultaneously display an aural representation of said first word that includes said foreign language phoneme, but that would include said native language phoneme if pronounced correctly.

17. The method of claim 16, wherein said validating step comprises the substeps of:
generating, by said processor, an output signal configured to control said audio display device to display an aural representation of a second native language word that includes said foreign language phoneme, but that would contain said native language phoneme if correctly pronounced, without simultaneously displaying a written representation of said second word; and
generating, by said processor, an output signal to control said visual display monitor to display a written representation of said second word following said aural display of said second word to allow said user to verify the correct substitution of said native language phoneme for said foreign language phoneme was made.

18. The method of claim 14, further comprising the steps of:
receiving, by said processor, an input signal representative of a command to initiate a routine comprising said training and validating steps;
processing, by said processor, said input signal; and
initiating, by said processor, said routine in response to said input signal.

19. The method of claim 14, further comprising accessing, by said processor, a computer program from a computer-readable storage medium that includes code that, when executed by said processor, causes said computer system to perform said training and validating steps.

20. The method of claim 14, further comprising communicating said computer program between a remotely located computer system and said computer system over a computer network.

21. A system for teaching a native language speaking user to decode or decipher a foreign accent, comprising:
a means for assessing whether said user has a desired level of (i) understanding of the nature of a mispronunciation of a native language word by a foreign language speaker, and (ii) comprehension of said response to said mispronunciation;
a means for training said user to understand the nature of said mispronunciation and to comprehend a response to said mispronunciation; and
a means for validating said user's understanding and comprehension by allowing said user to determine whether said response was accurately performed following an aural display of said mispronunciation through an audio display device.
